(19) United States
(12) Patent Application Publication
(10) Pub. No.: US 2014/0076446 A1
(43) Pub. Date: Mar. 20, 2014

(54) FLUID FLOW IMPEDANCE SYSTEM

(71) Applicants: Maria M. O'Connell, Cypress, TX (US); John Buffington, Williston, ND (US)

(72) Inventors: Maria M. O'Connell, Cypress, TX (US); John Buffington, Williston, ND (US)

(21) Appl. No.: 13/621,456

(22) Filed: Sep. 17, 2012

(51) Int. Cl. F16L 55/16

(52) U.S. Cl. CPC F16L 55/16
USPC 138/98

(57) ABSTRACT

A fluid flow impedance system including a member having a wall with at least one opening therethrough and a tool positionable relative to the at least one opening. The tool has a carrier with an expandable material disposed therewith. The expandable material is operatively arranged to expand into the at least one opening, in response to the expandable material experiencing a predetermined condition, for impeding a flow of fluid through the at least one opening.

### BACKGROUND

Occasionally in the downhole drilling and completions industry it is desirable to prevent fluid flow from one location to another. Valves and other flow control devices are implemented for this purpose. However, situations may occur where fluid flow control is desired between locations unexpectedly or not originally intended, devices or components malfunction or fail (e.g., leak), valves or other devices are impractical or unfeasible, etc. For example, one situation is if a packer, valve, pipe joint, etc., develops a leak that is desired to be sealed. Another situation is where it is desired to re-fracture an existing well (e.g., that has reached the end of its effective life) in order to produce fluids, e.g., hydrocarbons, that are trapped or otherwise remaining in a downhole formation after a fracturing operation. In this example, the fracture ports or perforations must be re-sealed in order to enable the fracturing of unfractured zones or unfractured portions of zones, the re-fracture of partially fractured zones, etc. In view hereof, the industry would well receive a system for enabling the on-demand sealing of fluid flow openings, e.g., for sealing leaks, performing re-fracture operations, etc.

### SUMMARY

A fluid flow impedance system including a member having a wall with at least one opening therethrough; and a tool positionable relative to the at least one opening, the tool having a carrier with an expandable material disposed therewith, the expandable material operatively arranged to expand into the at least one opening in response to the expandable material experiencing a predetermined condition for impeding a flow of fluid through the at least one opening.

A method of impeding flow including positioning a tool adjacent to at least one openings in a wall of a member, the tool having a carrier with a volume of an expandable material thereon; subjecting the expandable material to a predetermined condition corresponding to the expandable material; expanding the expandable material into the at least one opening in response to the predetermined condition; and impeding fluid flow through the at least one opening with the expandable material.

### BRIEF DESCRIPTION OF THE DRAWINGS

The following descriptions should not be considered limiting in any way. With reference to the accompanying drawings, like elements are numbered alike:

FIG. 1 is a cross-sectional view of a tool for closing one or more openings in a wall adjacent to the tool according to one embodiment disclosed herein;

FIG. 2 is a cross-sectional view of a tool according to one embodiment disclosed herein arranged for closing openings in a wall of a tubular string; and

FIGS. 3-6 schematically illustrate the performance of a re-fracturing operation using the tool of FIG. 1.

### DETAILED DESCRIPTION

A detailed description of one or more embodiments of the disclosed apparatus and method are presented herein by way of exemplification and not limitation with reference to the Figures.

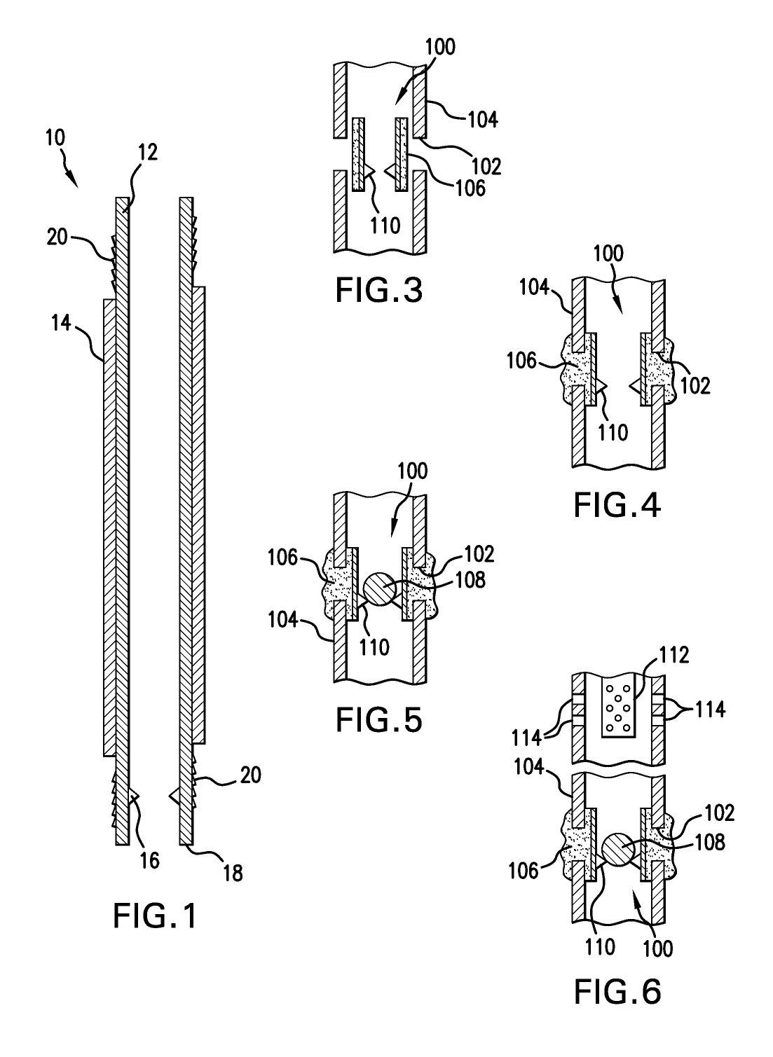

Referring now to the Figures, a tool 10 is shown in FIG. 1. The tool 10 includes a body or carrier 12 for supporting a volume of an expandable material 14. The expandable material 14 is arranged to expand or swell upon exposure to a predetermined condition. Namely, by use of the expandable material 14, tools according to the current invention as described herein can be utilized for any task in which a port, perforation, or opening (generally “opening”) is desired to be filled, blocked, sealed, etc. In order to prevent fluid flow through these openings, the material 14 may be made from a generally fluid impermeable material such as a closed-cell foam.

In one embodiment, the material 14 is formed at least partially from a shape-memory material, with the predetermined condition relating to a change in some parameter such as temperature, pressure, pH, etc. This change in parameter triggers a transition of the shape-memory material from a deformed configuration to an expanded, original configuration. In one embodiment, the transition between deformed and original configurations is achieved by elevating the temperature of the expandable material 14 above a glass transition temperature of the shape-memory material. Ambient downhole temperature, heaters or heat sources, heated fluids pumped downhole, etc., could be used to provide the heat necessary to trigger transition of such a shape-memory material. Alternatively or additionally, a variety of swellable foams and swellable materials are known in the art and swell in response to a selected fluid such as water or other aqueous fluids (brine), oil or other hydrocarbon based fluids, etc. Any of these fluid-responsive swellable foams or other swellable materials are suitable for use to form at least a part of the expandable material 14, with the predetermined condition being the presence of the selected fluid. Those of ordinary skill in the art will of course recognize that the expandable material 14 could include other types of expandable materials or combinations with or of the types of materials described above, and that other conditions or combinations of conditions could be used for triggering the expansion of the expandable material 14.

The tool 10 optionally includes a seat 16 for receiving a ball or plug in order to block fluid flow axially through the tool 10, thereby enabling the tool 10 to provide both radial and axial isolation. Advantageously, the inclusion of the seat 16 avoids the need for a separate bridge plug or similar device to block flow axially in a completion or the like. In order to locate the tool 10 for its intended use, the tool 10 may land at component or feature in a borehole hole or completion by directly engaging an end 18 of the carrier 12 against the component or feature. In one embodiment, the end 18 may include a designated landing feature, e.g., a profiled flange or projection sized to engage with a complementarily formed landing nipple or profile. In other embodiments, the tool 10 may be located by measuring a distance that the tool 10 is run-in, and then anchored in place using one or more sets of slips 20. It is to be appreciated that even if the tool 10 lands with the end 18 on some corresponding feature in a completion or the like, that the slips 20 can nevertheless be utilized to lock or anchor the tool 10 in place. The slips 20 could take any desired or known form and be triggered, e.g., hydraulically, mechanically (e.g., via a shifting tool), electrically, etc.

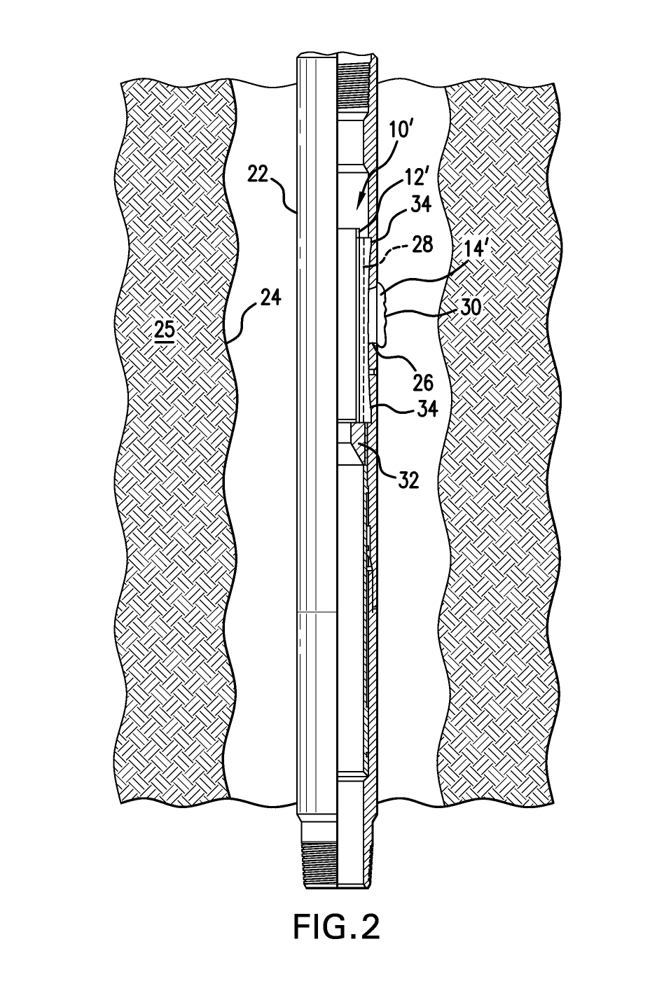

As previously noted, the expandable material 14 is intended to expand or swell in order to fill one or more openings in a wall of a tubular or other member located adjacent, e.g., radially adjacent, to the tool 10. An example is depicted in FIG. 2, in which a tool 10′ is arranged within a tubular, string, or other member 22 located within a borehole 24 through or proximate to a formation 25. The tool 10′ generally resembles the tool 10, e.g., including a carrier 12′, a volume of expandable material 14′, etc. It is to be appreciated that aspects of the various tools discussed herein are generally interchangeable and/or rearrangable between various embodiments and that different reference numbers are provided merely for the sake of discussing the various embodiments illustrated in the Figures. The member 22 includes one or more openings 26 that are able to be sealed, blocked, or plugged with the expandable material 14′ of the tool 10′ in order to prevent a flow of fluid through the openings 26. As noted above, this enables the tool 10′ to close openings that may adversely affect operations requiring hydraulic pressure, the production or stimulation of a borehole, etc.

When run-in, the material 14′ has a deformed configuration 28, indicated by a dashed line. Once the material 14′ is subjected to its corresponding predetermined condition (e.g., temperature, pH, pressure, water, oil, etc.), the material 14′ expands into a second configuration 30, which at least partially fills the openings 26. In the illustrated embodiment, the material 14′ is shown “mushrooming” or axially expanding once radially through the openings 26, which helps immovably secure the tool 10′ with respect to the member 22. As noted above, the expansion of the material 14′ could be triggered by a shape-memory material attempting to return to its default, natural, or original configuration, a swellable material swelling upon absorption of a corresponding fluid, etc. It is noted that tools according to the current invention as described herein could be arranged to have material that expands in some other direction, e.g., radially inwardly, with the tool positioned radially outwardly of the openings in the wall of a tubular or other member to be sealed.

The openings 26 in the embodiment of FIG. 2 are illustrated as ports corresponding to a sliding sleeve valve assembly originally adapted for selectively opening and closing the ports for enabling fracturing, stimulation, production, etc. A portion of a sleeve 32 of the aforementioned valve assembly in illustrated in FIG. 2. The portion results, for example, from milling out the sleeve 32 prior to running-in the tool 10′ in order to form a suitable landing location for receiving the tool 10′ and/or the carrier 12′ of the tool 10′. In other embodiments, the tool 10′ could be run-in without first milling. Of course it should also be recognized that in some completions fracturing is done through perforations, not valve control ports, so the tool 10′ could be adapted to land at a nearby nipple, profile, or other feature in lieu of landing on a sleeve or a portion thereof In addition to milling the sleeve 32 in the illustrated embodiment, the member 22 could also be milled for creating undercuts 34. Alternatively, the undercuts 34 could be formed via some other process or present in the member 22 prior to completing the borehole 24 in anticipation of later engagement with the tool 10′. In one embodiment, the undercuts 34 are formed by erosion as sand or other particulate, e.g., in a fracturing fluid, is pumped through the openings 26. The undercuts 34 are arranged to receive the material 14 when it expands in order to create radial overlap between the material 14′ and the member 22, which assists in securing the member 22 and the tool 10′ together.

In one embodiment, tools according to the current invention (e.g., the tools 10 and 10′) are used for re-fracturing operations, that is, in order to again fracture a completion that has already been fractured and produced from in order to produce hydrocarbons or other desired fluids that remained trapped in downhole formations. An example of a re-fracture operation is schematically shown in FIGS. 3-6. In this example, a tool 100 (generally resembling any of the tools or combinations of features of tools described herein) is run downhole and positioned with respect to a set of openings 102 (e.g., perforations, ports, etc.) in a wall of a structure or member 104 (e.g., tubular, string, etc.). An expandable material 106 on the tool 100 is arranged to expand in response to its corresponding predetermined condition (e.g., temperature, pressure, pH, water, oil, etc., as described above) in order to block, fill, or seal the perforations, ports, or other openings 102. In order to prevent fluid flow from traveling axially downhole, a dart, ball, or plug 108 is dropped downhole and engaged with a seat 110 of the tool 100. Thereafter, a new set of openings can be formed in the member 104 adjacent to a location to be fractured (e.g., where trapped hydrocarbons or other desired fluids are predicted to be) by lowering one or more perforation guns 112 into the member 104, e.g., on wireline, coiled tubing, etc. The perforation guns 112 receive a signal or are otherwise activated, e.g., via hydraulic pressure, an electrical signal, etc., to set off charges, making perforations 114 in the member 104. Since the plug 108 and the seat 110 block off axial flow and isolate opposite sides of the tool 100 from each other, pressurized fluid can be directed to the formation through the perforations 114 in order to re-fracture the formation. In this way, for example, older wells that are not producing efficiently can be re-fractured in order to stimulate the production of a greater percentage of the desired fluids located in nearby formations. Advantageously, this enables the production of hydrocarbons or other fluids from existing wells without the need to drill new boreholes and install new completions.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A fluid flow impedance system, comprising:
a member having a wall with at least one opening therethrough; and
a tool positionable relative to the at least one opening, the tool having a carrier with an expandable material disposed therewith, the expandable material operatively arranged to expand into the at least one opening, in response to the expandable material experiencing a predetermined condition, for impeding a flow of fluid through the at least one opening.

2. The system of claim 1, wherein the expandable material is a foam.

3. The system of claim 1, wherein the predetermined condition is the presence of a selected fluid.

4. The system of claim 3, wherein the selected fluid is oil, water, or a combination including at least one of the foregoing.

5. The system of claim 1, where in the predetermined condition is a change in a downhole parameter.

6. The system of claim 5, wherein the downhole parameter relates to temperature, pressure, pH, or a combination including at least one of the foregoing.

7. The system of claim 1, further comprising an anchor device for preventing movement of the tool relative to the member together after the tool is positioned.

8. The system of claim 7, wherein the anchor device is one or more sets of slips.

9. The system of claim 1, wherein the at least one opening includes a port of a fracture sleeve assembly, one or more perforations, or a combination including at least one of the foregoing.

10. The system of claim 1, wherein the member is part of a tubular string.

11. The system of claim 1, further comprising a seat for receiving a plug, the seat and plug operative together to isolate opposite sides of the seat from each other.

12. The system of claim 11, wherein the tool comprises the seat.

13. The system of claim 1, wherein the member has an undercut for receiving the expanded material when the expanded material becomes expanded for preventing movement of tool relative to the member.

14. The system of claim 1, wherein the at least one opening extends radially through the wall.

15. The system of claim 1, wherein the tool is positioned radially inwardly of the member.

16. A method of impeding fluid flow, comprising:
positioning a tool adjacent to at least one openings in a wall of a member, the tool having a carrier with a volume of an expandable material thereon;
subjecting the expandable material to a predetermined condition corresponding to the expandable material;
expanding the expandable material into the at least one opening in response to the predetermined condition; and
impeding fluid flow through the at least one opening with the expandable material.

17. The method of claim 16, wherein the member is positioned in a borehole proximate to a downhole formation, further comprising pumping a pressurized fluid into the member to perform one or more operations.

18. The method of claim 17, wherein the one or more operations comprises a re-fracturing of the downhole formation.

19. The method of claim 18, wherein prior to re-fracturing the downhole formation, one or more other openings are created in the member for directing the pressurized fluid to the formation.

20. The method of claim 19, wherein the one or more other openings are formed as perforations with a perforation gun.

21. The method of claim 16, wherein the tool includes a seat, the method further comprising receiving a plug at the seat for isolating opposite sides of the tool from each other.
